(19) United States
(12) Patent Application Publication
(10) Pub. No.: US 2015/0346390 A1
(43) Pub. Date: Dec. 3, 2015

(54) OPTICAL FILM, POLARIZING PLATE AND LIQUID CRYSTAL DISPLAY DEVICE

(71) Applicant: FUJIFILM Corporation, Tokyo (JP)

(72) Inventors: Masato NAGURA, Kanagawa (JP); Mamoru SAKURAZAWA, Kanagawa (JP); Ryo SUZUKI, Kanagawa (JP)

(73) Assignee: FUJIFILM Corporation, Tokyo (JP)

(21) Appl. No.: 14/725,674

(22) Filed: May 29, 2015

(30) Foreign Application Priority Data
May 30, 2014 (JP) 2014-113536

(51) Int. Cl. G02B 1/14; C08J 5/18; G02F 1/1335

(52) U.S. Cl. CPC G02B 1/14; G02F 1/133528; C08J 5/18; C08J 2301/12; C08J 2467/02

(57) ABSTRACT

An optical film having a thickness of from 10 to 45 μm and containing a cellulose ester and a polyester having a recurring unit represented by the formula 1 and having a terminal blocked with an alicyclic structure wherein Re and Rth are from −5 to 5 nm at a wavelength of 590 nm can be used as an polarizing plate protective film and is capable of ensuring excellent film surface smoothness and the durability of a polarizer under a high temperature and high humidity environment. X represents an acyclic divalent linking group, R represents an alkyl, alkenyl, alkynyl or aryl group, and m represents an integer of from 0 to 4.

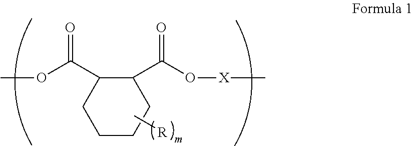

### CROSS-REFERENCE TO RELATED APPLICATIONS

The present application claims the benefit of priority from Japanese Patent Application No. 113536/2014, filed on May 30, 2014, the contents of which are herein incorporated by reference in their entirety.

### BACKGROUND OF THE INVENTION

1. Field of the Invention

The invention relates to an optical film, a polarizing plate and a liquid crystal display device. More specifically, the invention relates to an optical film useful in a liquid crystal display, and a polarizing plate and a liquid crystal display device containing the optical film.

2. Background Art

A cellulose ester film, which is represented by a cellulose acetate film, has high transparency and thus has been used as an optical film for various purposes in a liquid crystal display device. For example, a cellulose ester film is used as a polarizing plate protective film in a liquid crystal display device since adhesiveness to polyvinyl alcohol used in a polarizer may be easily secured

In recent years, a liquid crystal display device, particularly a liquid crystal display device for a middle sized or small sized equipment, undergoes drastic reduction in thickness, and thus reduction in thickness of members used therein, particularly reduction in thickness of a polarizing plate protective film (such as a protective film having a hardcoat layer provided on a surface of a liquid crystal device, a protective film functioning as a retardation film, and an ordinary protective film having a small retardation), is being demanded. A middle sized or small sized liquid crystal display device is often exposed to severe environmental changes, for example, in outdoors, and the durability thereof under a high temperature and high humidity environment is an important capability. The progress of reduction in thickness of the polarizing plate protective film may increase the polarizer protecting function demanded per unit thickness as well as good film surface smoothness, and thus there is more than ever a demand of a thin optical film that is capable of ensuring the durability of the polarizer under a high temperature and high humidity environment and film surface smoothness.

As a film used in a liquid crystal display device, for example, Patent Reference 1 describes that a cellulose acylate film containing a polyester polymer containing a polyester component, which is derived from a diol containing an alicyclic structure and a dicarboxylic acid derivative having an alicyclic structure, and cellulose acylate has a high tear strength.

Patent Reference 2 describes that a cellulose ester film containing an ester plasticizer having benzene carboxylic acid or phenol residual groups at both terminals thereof and having an alicyclic glycol and an alicyclic dibasic acid has an increased durability of the optical capability against humidity change.

Patent Reference 3 describes that a polyester resin modifier having cyclohexane rings or cyclohexene rings in the main chain skeleton thereof, in which the rings forma polymer through ester bonds at the 1-position and the 2-position of the ring, may enhance the moisture permeability resistance of a cellulose ester film and may suppress fluctuation of the retardation in the thickness direction Rth thereof due to humidity fluctuation.

### PATENT REFERENCES

### Patent Reference 1: JP-A-2004-292696

### Patent Reference 2: JP-A-2007-84692

### Patent Reference 3: WO 2014/027594

### SUMMARY OF INVENTION

An optical film used in an IPS liquid crystal display device preferably has a low retardation, but it has been found that the films described in Patent References 1 and 2 exhibit a high retardation and considerably deteriorate the display performance of an IPS liquid crystal display device using the films.

It has been found that the film described in Patent Reference 3 has a low retardation and provides excellent display performance for an IPS liquid crystal display device, but is still insufficient in the film smoothness and the durability of the polarizer under a high temperature and high humidity environment.

A problem to be solved by the invention is to provide an optical film that achieves a thin film thickness, and is capable of achieving optical characteristics with a low retardation, excellent film surface smoothness and high durability of a polarizer under a high temperature and high humidity environment on application to a polarizing plate.

The comparison between Examples and Comparative Example 12 of Patent Reference 3 reveals a tendency that a polyester resin modifier having a main chain skeleton polymerized through ester bonds at the 1-position and the 2-position of the cyclohexane rings may suppress fluctuation of Rth due to humidity fluctuation, rather than a polyester resin modifier having a main chain skeleton polymerized through ester bonds at the 1-position and the 4-position of the cyclohexane rings.

Under the circumstances, the present inventors have made earnest investigations for solving the problem, but even though some kinds of the polyester having a main chain skeleton polymerized through ester bonds at the 1-position and the 2-position of the cyclohexane rings described in Patent Reference 3 are studied, they are not successful in large enhancement of the durability of a polarizer. Accordingly, it has been found that there is no such significant relationship between the suppression of fluctuation of Rth due to humidity fluctuation and the high durability of the polarizer under a high temperature and high humidity environment. On the other hand, it has been found that a polyester resin modifier having a main chain skeleton polymerized through ester bonds at the 1-position and the 2-position of the cyclohexane rings has high durability of the polarizer under a high temperature and high humidity environment, rather than a polyester resin modifier having a main chain skeleton polymerized through ester bonds at the 1-position and the 4-position of the cyclohexane rings.

Thus, the inventors have investigated polyesters polymerized through ester bonds at the 1-position and the 2-position of the cyclohexane rings other than the polyesters described in Patent Reference 3, and as a result, it has been found that an optical film capable of solving the problem may be obtained by using a cellulose ester in combination with a polyester containing a repeating unit having a 1,2-cyclohexanedicarboxylic structure and having a terminal blocked with a group having alicyclic structure.

The invention which is means for solving the above problems includes the followings:

[1] An optical film containing:

a cellulose ester, and

a polyester having a recurring unit represented by the formula 1 below and having a terminal blocked with a group having an alicyclic structure,

wherein:

the optical film has a thickness of from 10 to 45 μm,

the optical film has an in-plane retardation, Re, of from −5 to 5 nm at a wavelength of 590 nm under an environment of 25° C. and a relative humidity of 60%, and

the optical film has a retardation in thickness direction, Rth, of from −5 to 5 nm at a wavelength of 590 nm under an atmosphere at 25° C. and a relative humidity of 60%:

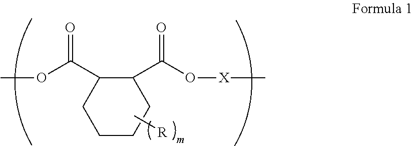

wherein X represents a divalent linking group having from 2 to 10 carbon atoms,

R represents an alkyl group having from 1 to 8 carbon atoms, an alkenyl group having from 2 to 8 carbon atoms, an alkynyl group having from 2 to 8 carbon atoms, or an aryl group having 6 carbon atoms, R may form a cyclic structure and may have a substituent; the above numbers of carbon atoms do not include the number of carbon atoms in a substituent the group represented by R may further have; and

m represents an integer of from 0 to 4.

[2] The optical film of [1] wherein the polyester has a number average molecular weight, Mn, of from 500 to 3000.
[3] The optical film of [1] wherein X in the formula 1 an acyclic divalent linking group having from 2 to 4 carbon atoms.
[4] The optical film of [1] wherein the group having an alicyclic structure is a group having a cycloalkyl group having 4 to 12 carbon atoms.
[5] The optical film of [1] wherein the group having an alicyclic structure is a group having a cycloalkyl group having 6 to 12 carbon atoms and the group having a cycloalkyl group having 6 to 12 carbon atoms has at least one cyclohexyl ring.
[6] The optical film of [1] wherein the polyester is contained in an amount of from 5 to 20% by mass based on the amount of the cellulose ester.
[7] A polarizing plate containing a polarizer and at least one sheet of the optical film of [1].
[8] A liquid crystal display device containing a liquid crystal cell and two polarizing plates disposed on both sides of the liquid crystal cell, wherein at least one of the polarizing plates is the polarizing plate of [7].
[9] The liquid crystal display device of [8], wherein the liquid crystal cell is an in-plane switching IPS mode liquid crystal cell.
[10] The liquid crystal display device of [8], wherein the optical film of [1] is disposed between the polarizer and the liquid crystal cell.

The invention can provide an optical film that achieves a thin film thickness, and is capable of achieving optical characteristics with a low retardation, excellent film surface smoothness and high durability of a polarizer under a high temperature and high humidity environment on application to a polarizing plate as a polarizing plate protective film.

The invention can provide a polarizing plate and liquid crystal display device using the optical film.

### DESCRIPTION OF EMBODIMENTS

The invention will be described in detail with reference to embodiments below. While the constitutional elements of the invention may be described with reference to the embodiments, the invention is not limited to the embodiments. In the description, the expression for numeral ranges “from A to B” means that the values A and B are included in the range as the lower and upper limits respectively, and the expression for numeral ranges “A or more” or “A or less” means that the value A is included in the range as the lower or upper limit respectively.

### [Optical Film]

The optical film of the invention contains a cellulose ester and a polyester having a recurring unit represented by the formula 1 below and having a terminal blocked with a group having an alicyclic structure. The optical film has a thickness of from 10 to 45 μm. The optical film has an in-plane retardation (Re) of from −5 to 5 nm at a wavelength of 590 nm under an environment of 25° C. and 60% RH, and a retardation in thickness direction (Rth) of from −5 to 5 nm at a wavelength of 590 nm under an atmosphere at 25° C. and 60% RH.

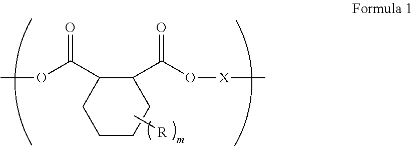

In the formula 1, X represents a divalent linking group having from 2 to 10 carbon atoms. R represents an alkyl group having from 1 to 8 carbon atoms, an alkenyl group having from 2 to 8 carbon atoms, an alkynyl group having from 2 to 8 carbon atoms, or an aryl group having 6 carbon atoms, R may forma cyclic structure and may have a substituent; the above numbers of carbon atoms do not include the number of carbon atoms in a substituent the group represented by R may further have. m represents an integer of from 0 to 4.

The optical film of the invention having the above components achieves a thin film thickness, and is capable of achieving optical characteristics with a low retardation, excellent film surface smoothness and high durability of a polarizer under a high temperature and high humidity environment on application to a polarizing plate as a polarizing plate protective film.

Preferable embodiments of the optical film of the invention will be described below:

### Cellulose Ester

The optical film of the invention contains a cellulose ester. The optical film of the invention preferably contains one or more kinds of a cellulose ester as a major component. Examples of the cellulose ester include a cellulose ester compound and a compound having an ester-substituted cellulose structure obtained by introducing biologically or chemically a functional group to cellulose as a raw material. The term “major component” herein means, in the case where only one kind of a polymer is contained, the polymer, and in the case where two or more kinds of polymers are contained, the polymer that has the largest mass fraction.

The cellulose ester is an ester of cellulose and an acid. The acid constituting the ester is preferably an organic acid, more preferably a carboxylic acid, further preferably a fatty acid having from 2 to 22 carbon atoms, and most preferably a lower fatty acid having from 2 to 4 carbon atoms, forming cellulose acylate.

Examples of cellulose as a raw material of the cellulose acylate include cotton linter and wood pulp (such as hardwood pulp and softwood pulp), and all kinds of cellulose obtained therefrom may be used and may be used after mixing plural kinds thereof depending on necessity. For the cellulose as a raw material, reference may be made, for example, to “Plastic Zairyo Koza (17) Senisokei Jushi” (Lectures on Plastic Materials (17) Cellulose Resins), by Marusawa and Uda, published by Nikkan Kogyo Shimbun, Ltd., 1970, and JIII Journal of Technical Disclosure Monthly, 2001-1745 (pp. 7-8), and all kinds of cellulose described therein may be used.

The cellulose acylate used in the embodiment is obtained by substituting a hydrogen atom of a hydroxyl group of cellulose by an acyl group. The acyl group preferably has from 2 to 22 carbon atoms. The acyl group may be an aliphatic acyl group or an aromatic acyl group, and the cellulose may be substituted by one kind of an acyl group or by plural kinds of acyl groups. Specific examples of the cellulose acylate include an alkylcarbonyl ester, an alkenylcarbonyl ester, an aromatic carbonyl ester and an aromatic alkylcarbonyl ester of cellulose. The alkyl moiety, the alkenyl moiety, the aromatic moiety and the aromatic alkyl moiety may further have a substituent. Preferred examples of the acyl group include acetyl, propionyl, butanoyl, heptanoyl, hexanoyl, octanoyl, decanoyl, dodecanoyl, tridecanoyl, tetradecanoyl, hexadecanoyl, octadecanoyl, i-butanoyl, t-butanoyl, cyclohexanecarbonyl, oleoyl, benzoyl, naphthylcarbonyl and cinnamoyl groups. Among these, acetyl, propionyl, butanoyl, dodecanoyl, octadecanoyl, t-butanoyl, oleoyl, benzoyl, naphthylcarbonyl, cinnamoyl and the like are preferred, acetyl, propionyl and butanoyl are more preferred, and acetyl is most preferred.

The acylation degree of the cellulose acylate used is not particularly limited, and the cellulose acylate that has an acylation degree of from 2.00 to 2.95 is preferably used from the standpoint of the film forming property and the various characteristics of the film thus produced. The acylation degree may be obtained by measuring the ratio of a fatty acid, such as acetic acid, bonded to the cellulose, from which the acylation degree may be calculated. The acylation degree may be measured according to ASTM D-817-91.

In an example of the cellulose acylate having two or more kinds of an acyl groups selected from an acetyl group, a propionyl group and a butanoyl group, the total acylation degree is preferably from 2.50 to 2.95, more preferably from 2.60 to 2.95, and further preferably from 2.65 to 2.95.

In an example of the cellulose acylate having only an acetyl group, i.e., cellulose acetate, the total acetylation degree is preferably from 2.00 to 2.95, more preferably from 2.40 to 2.95, and further preferably from 2.85 to 2.95.

The polymerization degree of the cellulose acylate that is preferably used in the embodiment is preferably from 180 to 700 in terms of viscosity average polymerization degree, and for cellulose acetate, the polymerization degree thereof is more preferably from 180 to 550, further preferably from 180 to 400, and particularly preferably from 180 to 350, in terms of viscosity average polymerization degree. When the polymerization degree is not more than the upper limit, the dope solution of the cellulose acylate may not have a too high viscosity, and a film may be readily produced by casting. When the polymerization degree is not less than the lower limit, problems including a too low strength of the film may be avoided. The viscosity average polymerization degree may be measured by the limiting viscosity method by Uda, et al. (see K. Uda and H. Saito, Journal of the Society of Fiber Science and Technology, Japan, vol. 18, No. 1, pp. 105-120 (1962)). The measurement method is also described in detail in JP-A-9-95538.

The molecular weight distribution of the cellulose acylate that is preferably used in the embodiment may be evaluated by gel permeation chromatography, and the polydispersion index Mw/Mn (wherein Mw represents the weight average molecular weight, and Mn represents the number average molecular weight) thereof is preferably small, i.e., the molecular weight distribution is preferably narrow. Specifically, the value of Mw/Mn is preferably from 1.0 to 4.0, more preferably from 2.0 to 4.0, and further preferably from 2.3 to 3.4.

### Polyester

The polyester used in the invention will be described below.

The polyester used in the invention has a recurring unit represented by the following formula 1 and has a terminal blocked with a group having an alicyclic structure.

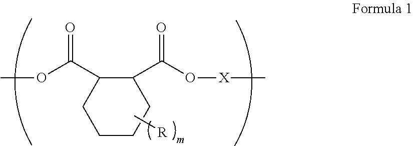

In the formula 1, X represents an divalent linking group having from 2 to 10 carbon atoms. R represents an alkyl group having from 1 to 8 carbon atoms, an alkenyl group having from 2 to 8 carbon atoms, an alkynyl group having from 2 to 8 carbon atoms, or an aryl group having 6 carbon atoms, R may forma cyclic structure and may have a substituent. The above numbers of carbon atoms do not include the number of carbon atoms in a substituent the group represented by R may further have. m represents an integer of from 0 to 4.

The polyesters having a recurring unit containing an alicyclic structure can reduce an in-plane retardation (Re) at a wavelength of 590 nm under an environment of 25° C. and 60% RH, and a retardation in thickness direction (Rth) at a wavelength of 590 nm under an atmosphere at 25° C. and 60% RH more than polyesters having a recurring unit containing an aromatic ring structure.

It is preferable that the high rigidity and low retardation of the film are both achieved by increasing the content of the rigid alicyclic structure in the polyester having the above structure.

In the formula 1, X represents a divalent linking group having from 2 to 10 carbon atoms, preferably an acyclic divalent linking group having from 2 to 10 carbon atoms, more preferably an acyclic divalent linking group having from 2 to 6, and still more preferably an acyclic divalent linking group having from 2 to 4.

Examples of the divalent linking group having from 2 to 10 carbon atoms include an alkylene group (preferably having from 2 to 10 carbon atoms, more preferably from 2 to 6 carbon atoms, and particularly preferably from 2 to 4 carbon atoms) and an alkynylene group (preferably having from 2 to 10 carbon atoms, more preferably from 2 to 6 carbon atoms, and particularly preferably from 2 to 4 carbon atoms), and a linking group containing an atom other than carbon, such as an oxygen atom and a nitrogen atom, in an alkylene group or an alkynylene group.

The divalent linking group having from 2 to 10 carbon atoms may have a substituent, and examples of the substituent include an alkyl group, an alkoxy group, a hydroxyl group, an alkoxy-substituted alkyl group and a carboxyl group.

The term “acyclic” herein means one that does not contain a cyclic structure, examples of a group that does not contain a cyclic structure include a linear group and a branched group.

In the formula 1, R represents an alkyl group having from 1 to 8 carbon atoms, an alkenyl group having from 2 to 8 carbon atoms, an alkynyl group having from 2 to 8 carbon atoms or an aryl group having 6 carbon atoms, may form a cyclic structure, and may have a substituent. The above numbers of carbon atoms do not include the number of carbon atoms in a substituent the group represented by R may further have. Examples of the alkyl group having from 1 to 8 carbon atoms include a methyl group, an ethyl group, a propyl group, a butyl group, an isobutyl group, a pentyl group, a hexyl group, an octyl group and a 2-ethylhexyl group, and an alkyl group having from 1 to 4 carbon atoms is preferred, and a methyl group and an ethyl group are more preferred. Examples of the alkenyl group having from 2 to 8 carbon atoms include an ethenyl group, a 1-methylethenyl group, a 1-propenyl group, a 2-propenyl group, a 2-methyl-1-propenyl group, 2-methyl-2-propenyl group and a 2-methylenebutyl group. Examples of the alkynyl group having from 2 to 8 carbon atoms include an ethynyl group, a 1-methylethynyl group, a 1-propynyl group, a 2-propynyl group, a 2-methyl-1-propynyl group, a 2-methyl-2-propynyl group and a 2-methylenebutynyl group. Examples of the aryl group having 6 carbon atoms include a phenyl group and a 4-methylphenyl group. R may form a cyclic structure, and examples of the cyclic structure include a cyclohexyl group, a cyclooctyl group, a bornyl group, an isobornyl group and a norbornyl group. R may have a substituent, and examples of the substituent include an alkyl group, an alkoxy group, a hydroxyl group, an alkoxy-substituted alkyl group and a carboxyl group, and an alkyl group is preferred, and a methyl group and an ethyl group are more preferred. The above numbers of carbon atoms do not include the number of carbon atoms in a substituent the group represented by R may further have. For example, a methyl-substituted phenyl group is a phenyl group having 6 carbon atoms substituted with a methyl group, not a phenyl group having 7 carbon atoms.

In the formula 1, m represents an integer of from 0 to 4, preferably an integer of from 1 to 4, and more preferably an integer of from 1 to 2, and is particularly preferably 1 from the standpoint of the availability of the raw material. With m in a range of from 1 to 4, the equivalent effect of improving the durability of the polarizer may be obtained under a high temperature and high humidity environment. In this case, R is preferably substituted at the 4-position of the cyclohexyl ring contained in the repeating unit represented by the formula 1, from the standpoint of the reactivity and the availability of the raw material.

The polyester used in the invention is preferably a polyester oligomer synthesized from an aliphatic dicarboxylic acid as a dicarboxylic acid and an diol.

The dicarboxylic acids and the diols which are preferably used for synthesis of the polyester used in the invention will be described below.

The polyester used in the invention is preferably synthesized from an aliphatic diol having from 2 to 10 carbon atoms and a dicarboxylic acid having an alicyclic structure represented by the formula 2 below (dicarboxylic acid may be referred to as dibasic acid). More preferably, the polyester used in the invention is synthesized from an acyclic aliphatic diol having from 2 to 10 carbon atoms and a dicarboxylic acid having an alicyclic structure represented by the formula 2 below.

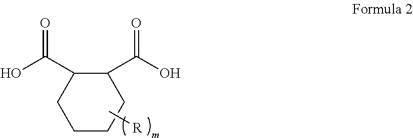

In the formula 2, R represents an alkyl group having from 1 to 8 carbon atoms, an alkenyl group having from 2 to 8 carbon atoms, an alkynyl group having from 2 to 8 carbon atoms, or an aryl group having 6 carbon atoms, R may forma cyclic structure and may have a substituent. The above numbers of carbon atoms do not include the number of carbon atoms in a substituent the group represented by R may further have. m represents an integer of from 0 to 4.

### Dicarboxylic Acid

As the dicarboxylic acid, at least a dicarboxylic acid represented by the formula 2 is preferably used.

The preferred ranges of R and m in the formula 2 are the same as the preferred ranges of R and m in the formula 1.

Specific examples of the dicarboxylic acid represented by the formula 2 include 3-methyl-1,2-cyclohexyldicarboxylic acid, 4-methyl-1,2-cyclohexyldicarboxylic acid, 4-ethyl-1,2-cyclohexyldicarboxylic acid, 4,5-dimethyl-1,2-cyclohexyldicarboxylic acid, 4-isobornyl-1,2-cyclohexyldicarboxylic acid and 4-phenyl-1,2-cyclohexyldicarboxylic acid. Among these, 4-methyl-1,2-cyclohexyldicarboxylic acid are preferred from the standpoint of the availability.

The polyester used in the invention may have a recurring unit not included in the formula 1 as a structural unit within the range not deteriorating the effect of the invention in addition to the recurring unit represented by the formula 1. The recurring unit not included in the formula 1 is preferably synthesized from an acyclic aliphatic diol having from 2 to 10 carbon atoms and an dicarboxylic acid not included in the formula 2. Examples of the dicarboxylic acid not included in the formula 2 include oxalic acid, malonic acid, succinic acid, maleic acid, fumaric acid, glutaric acid, adipic acid, pimelic acid and 1,4-cyclohexanedicarboxylic acid.

The content of the recurring unit represented by the formula 1 in the polyester used in the invention is preferably 80% by molar or more, and more preferably 90% by molar or more.

### Diol

Aliphatic diol having from 2 to 10 carbon atoms is preferred as a diol.

Examples of aliphatic diols having an alicyclic structure include 1,2-cyclohexanediol, 1,4-cyclohexanediol and 1,4-cyclohexanedimethanol.

Examples of acyclic aliphatic dials include an alkanediol, specific examples of which include ethylene glycol, 1,2-propanediol, 1,3-propanediol, 1,2-butanediol, 1,3-butanediol, 2-methyl-1,3-propanediol, 1,4-butanediol, 1,5-pentanediol, 2,2-dimethyl-1,3-propanediol (neopentyl glycol), 2,2-diethyl-1,3-propanediol(3,3-dimethylolpropane), 2-n-butyl-2-ethyl-1,3-propanediol (3,3-dimethylolheptane), 3-methyl-1,5-pentanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol and diethylene glycol.

The aliphatic diol is preferably at least one kind of ethylene glycol, 1,2-propanediol and 1,3-propanediol, more preferably at least one kind of ethylene glycol and 1,2-propanediol, and particularly preferably ethylene glycol from the standpoint of the compatibility with the cellulose. In the case where two kinds of aliphatic diols are used, ethylene glycol and 1,2-propanediol are preferably used.

The number of carbon atoms contained in glycol is preferably from 2 to 6, and particularly preferably from 2 to 4. In the case where two or more kinds of the glycols are used, the average value of the number of carbon atoms of the two or more kinds of glycols is preferably in the aforementioned range. When the number of carbon atoms of the glycol is in the range, the polyester may have high compatibility with the cellulose acylate, and the resulting optical film may be prevented from undergoing bleed out of the polyester in the production of the film and on stretching the film at a high temperature.

### Terminal Structure

The polyester used in the invention is a polyester having a terminal blocked with a group having an alicyclic structure. As the polyester, such a polyester is preferred that a terminal thereof has a terminal structure that is obtained through reaction with a monoalcohol having an alicyclic structure (or a compound that is a derivative of a monoalcohol and is capable of forming an ester bond to the terminal carboxyl group of the polyester) or a monocarboxylic acid having an alicyclic structure (or a compound that is a derivative of a monocarboxylic acid and is capable of forming an ester bond to the terminal hydroxyl group of the polyester). For example, in the case where a polyester having a terminal carboxyl group is obtained through reaction of a dibasic acid and a diol, the terminal thereof may be blocked with a monoalcohol residual group having an alicyclic structure through reaction of the polyester with a monoalcohol having an alicyclic structure. In the case where a polyester having a terminal hydroxyl group is obtained, the terminal thereof may be blocked with a monocarboxylic acid residual group having an alicyclic structure through reaction of the polyester with a monocarboxylic acid having an alicyclic structure. The blocking of the terminal with a hydrophobic functional group is effective for improvement of the durability of the polarizer of the polarizing plate under a high temperature and high humidity environment and film surface smoothness, and this may be caused by the function of delaying hydrolysis of the ester group.

The residual group referred herein is a partial structure of the polyester and shows a partial structure of the monomer constituting the polyester. For example, a monocarboxylic acid residual group formed with a monocarboxylic acid R—COOH is represented by R—CO—, and a monoalcohol residual group formed with a monoalcohol R—OH is represented by R—O—.

In the optical film of the invention, the group having an alicyclic structure is preferably a group having from 4 to 12 carbon atoms, more preferably a group having a cycloalkyl group having from 4 to 12 carbon atoms, and still more preferably a cycloalkyl group having from 6 to 12 carbon atoms. In the optical film of the invention, the group having an alicyclic structure is particularly preferably a group having a cycloalkyl group having from 6 to 12 carbon atoms in which a cyclohexane ring is included in the cycloalkyl group having from 6 to 12 carbon atoms.

In the optical film of the invention, it is also preferred that the terminal of the polyester has a terminal structure that has an ester bond formed by substituting a part of the carboxyl group with a group derived from a monoalcohol having an alicyclic structure (which may be hereinafter referred to as a monoalcohol residual group) (the terminal structure may be hereinafter referred to as a blocked hydrogen atom of the terminal hydroxyl group), and it is also preferred that the terminal of the polyester has a terminal structure having the hydrogen atom of the hydroxyl group that is substituted by an acyl group derived from a monocarboxylic acid having an alicyclic structure (which may be hereinafter referred to as a monocarboxylic acid residual group) (the terminal structure may be hereinafter referred to as a blocked hydrogen atom of the terminal hydroxyl group). Among these, it is more preferred that the terminal of the polyester has a terminal structure having the hydrogen atom of the hydroxyl group that is substituted by an acyl group derived from a monocarboxylic acid having an alicyclic structure.

The monoalcohol having an alicyclic structure is preferably a monoalcohol having an alicyclic structure having from 4 to 12 carbon atoms, more preferably a cycloalkyl monoalcohol having from 4 to 12 carbon atoms, and particularly preferably a cycloalkyl monoalcohol having from 6 to 12 carbon atoms. The monoalcohol having an alicyclic structure is further particularly preferably a cycloalkyl monoalcohol having from 6 to 12 carbon atoms, in which the cycloalkyl monoalcohol having from 6 to 12 carbon atoms contains at least one cyclohexyl ring. Specific examples thereof include cyclohexanol, 2-methylcyclohexanol, 3-methylcyclohexanol, 4-methylcyclohexanol, 2-ethylcyclohexanol, 4-ethylcyclohexanol, 4-isopropylcyclohexanol, 4-butylcyclohexanol, 4-tert-butylcyclohexanol, 2,5-dimethylcyclohexanol, 3,5-dimethylcyclohexanol, 4-cyclohexylcyclohexanol, cycloheptanol, cyclooctanol, cyclododecanol, cyclohexanemethanol, norborneol, 1-adamantanol and 2-adamantanol.

The monocarboxylic acid having an alicyclic structure is preferably a monocarboxylic acid having from 4 to 12 carbon atoms having an alicyclic structure, more preferably a cycloalkylmonocarboxylic acid having from 4 to 12 carbon atoms, and particularly preferably a cycloalkylmonocarboxylic acid having from 6 to 12 carbon atoms. The monocarboxylic acid having an alicyclic structure is further particularly preferably a cycloalkylmonocarboxylic acid having from 6 to 12 carbon atoms, in which the cycloalkylmonocarboxylic acid having from 6 to 12 carbon atoms contains at least one cyclohexyl ring. Specific examples thereof include cyclopropanecarboxylic acid, cyclobutanecarboxylic acid, cyclopentanecarboxylic acid, cyclohexanecarboxylic acid, 4-methylcyclohexanecarboxylic acid, 4-ethylcyclohexanecarboxylic acid, 4-propylcyclohexanecarboxylic acid and 4-tert-butylcyclohexanecarboxylic acid. Among these, cyclohexanecarboxylic acid and 4-methylcyclohexanecarboxylic acid are particularly preferred. The cycloalkylmonocarboxylic acid having from 6 to 12 carbon atoms, in which the cycloalkylmonocarboxylic acid having from 6 to 12 carbon atoms contains at least one cyclohexyl ring, includes a cycloalkylmonocarboxylic acid having from 6 to 12 carbon atoms and the like that each contain a condensed ring formed of the substituents on the cyclohexyl ring that are bonded to each other.

The monoalcohol having an alicyclic structure and the monocarboxylic acid having an alicyclic structure used for blocking may be a mixture of two or more kinds thereof. In this case, the both terminals of the polyester are preferably monoalcohol residual groups having an alicyclic structure or monocarboxylic acid residual groups having an alicyclic structure. The blocking of the terminal with a functional group that is hydrophobic and has a bulky alicyclic structure is effective for improvement of the durability of the polarizer of the polarizing plate under a high temperature and high humidity environment, and also may improve the stiffness of the film.

The polyester preferably has an acid value of 10 mgKOH/g or less, more preferably 5 mgKOH/g or less, and particularly preferably 1 mgKOH/g or less. The polyester preferably has a hydroxyl group value of 10 mgKOH/g or less, more preferably 5 mgKOH/g or less, and particularly preferably 1 mgKOH/g or less, from the standpoint of the enhancement of the polarizer durability under a high temperature and high humidity environment.

### Synthesis Method

The polyester used in the invention may be synthesized by known methods such as dehydrating condensation reaction of a dicarboxylic acnd and a diol or addition and dehydrating condensation reaction of dicarboxylic anhydride to glycol.

The polyester may be readily synthesized by a thermal melting condensation method with polyesterification reaction or ester exchange reaction of the dicarboxylic acid, the diol and a monoalcohol having an alicyclic structure or a monocarboxylic acid having an alicyclic structure for terminal blocking, or an interface condensation method of an acid chloride of the acid and the glycol.

The number average molecular weight (Mn) of the polyester in the embodiment is preferably from 500 to 3,000, more preferably from 600 to 1,500, and further preferably from 700 to 1,200. When the number average molecular weight of the polyester is 500 or more, the polyester may have low volatility, and the resulting optical film may be prevented from undergoing malfunction and process contamination due to volatilization thereof under a high temperature condition on stretching the optical film. When the number average molecular weight thereof is 3,000 or less, the polyester may have high compatibility with the cellulose ester, and the resulting optical film may be prevented from undergoing bleed out of the polyester in the production of the film and on stretching the film at a high temperature.

The number average molecular weight of the polyester used in the invention is measured and evaluated by gel permeation chromatography (GPC). More specifically, the measurement contains dissolving the polyester in tetrahydrofuran and measuring the number average molecular weight with a high speed gel permeation chromatography (GPC) available from Tosoh Corporation. The number average molecular weight (Mn) is calculated in terms of polystyrene.

### Addition Amount (Content)

The optical film of the embodiment preferably has a content of the polyester of from 5 to 20% by mass, more preferably from 5 to 18% by mas, and particularly preferably from 5 to 15% by mass, based on the cellulose ester. The polyester may be used solely or as a combination of two or more kinds thereof. In the case where two or more kinds thereof are contained, the total amount thereof is preferably in the aforementioned range.

### Ultraviolet Ray Absorbent

The optical film of the invention preferably contains an ultraviolet ray (UV) absorbent in addition to the cellulose ester. The UV absorbent contributes to improvement of the polarizer durability under a high temperature and high humidity environment. In particular, the addition of the UV absorbent is effective in the case where the optical film of the invention is used as a polarizing plate protective film which protects a polarizer in the polarizing plate or as a surface protective film of a liquid crystal display device.

The UV absorbent that may be used in the embodiment is not particularly limited, and any UV absorbent that has been used in a cellulose acylate film may be used. Examples of the UV absorbent include those described in JP-A-2006-184874. A polymer ultraviolet ray absorbent may also be preferably used, and the polymer ultraviolet ray absorbent described in JP-A-6-148430 may be preferably used.

The amount of the ultraviolet ray absorbent used is not determined unconditionally since the amount may vary depending on the kind of the ultraviolet ray absorbent, the use conditions and the like, and the ultraviolet ray absorbent is preferably contained in an amount of from 1 to 5% by mass based on the cellulose ester.

Examples of the ultraviolet ray absorbent include one having the following structure, but the ultraviolet ray absorbent added is not limited thereto.

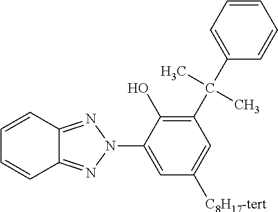

### Durability Improving Agent for Polarizer

The optical film of the invention may contain a durability improving agent for a polarizer as an additive for improving the durability of the polarizer under a high temperature and high humidity environment.

As the durability improving agent for a polarizer, known organic acid may be used. Examples of the known organic acids include organic acid monoglyceride such as polycarboxylic acid monoglyceride, particularly the compounds described in JP-A-2012-72348 and barbituric acid.

The optical film of the invention preferably has a content of the durability improving agent for a polarizer of 6% by mass or less, more preferably 4% by mass or less based on the cellulose ester.

### Additional Additive

The optical film of the embodiment may further contain at least one kind of an additional additive in such a range that does not impair the advantageous effects of the invention. Examples of the additional additive include a polymer plasticizer except for the polyester containing the repeating unit represented by the formula 1 and having a terminal blocked with a group having alicyclic structure (for example, a phosphate ester plasticizer, a carboxylate ester plasticizer, a polycondensation oligomer plasticizer and the like), an ultraviolet ray absorbent, an antioxidant, and a matting agent described later.

The content of the additional additive contained in the optical film of the embodiment is preferably 3% by mass or less, and more preferably 1% by mass or less, based on the cellulose ester, and the additional additive is further preferably not contained.

The content of a retardation inducing agent (which includes a retardation reducing agent) in the optical film of the embodiment is preferably 3% by mass or less, and more preferably 1% by mass or less, based on the cellulose ester, and the retardation inducing agent is further preferably not contained.

### Additional Polymer Plasticizer

The optical film of the embodiment may contain an additional polymer plasticizer in such a range that does not impair the advantageous effects of the invention. Examples of the polymer plasticizer include a polyester polyurethane plasticizer, an aliphatic hydrocarbon polymer, an alicyclic hydrocarbon polymer, an acrylic polymer, such as a polyacrylate ester and a polymethacrylate ester (examples of the ester-forming group of which include a methyl group, an ethyl group, a propyl group, a butyl group, an isobutyl group, a pentyl group, a hexyl group, a cyclohexyl group, an octyl group, a 2-ethylhexyl group, a nonyl group, an isononyl group, a tert-nonyl group, a dodecyl group, a tridecyl group, a stearyl group, an oleyl group, a benzyl group and a phenyl group), a vinyl polymer, such as a polyvinyl isobutyl ether and poly-N-vinylpyrrolidone, a styrene polymer, such as polystyrene and poly-4-hydroxystyrene, a polyether, such as polyethylene oxide and polypropylene oxide, a polyamide, a polyurethane, a polyurea, a phenol-formaldehyde condensate, a urea-formaldehyde condensate, and vinyl acetate.

Among these, an acrylic polymer is preferably used in combination. In the embodiment, a homopolymer or a copolymer synthesized from a monomer, such as an alkyl acrylate or methacrylate ester, is preferred as the acrylic polymer.

Example of an acrylate ester monomer having no aromatic ring include methyl acrylate, ethyl acrylate, propyl (including isopropyl and n-propyl) acrylate, butyl (including n-butyl, isobutyl, s-butyl and t-butyl) acrylate, pentyl (including n-pentyl, isopentyl and s-pentyl) acrylate, hexyl (including n-hexyl and isohexyl) acrylate, heptyl (including n-heptyl and isoheptyl) acrylate, octyl (including n-octyl and isooctyl) acrylate, nonyl (including n-nonyl and isononyl) acrylate, myristyl (including n-myristyl and isomyristyl) acrylate, 2-ethylhexyl acrylate, ε-caprolactone acrylate, 2-hydroxyethyl acrylate, 2-hydroxypropyl acrylate, 3-hydroxypropyl acrylate, 4-hydroxybutyl acrylate, 2-hydroxybutyl acrylate, 2-methoxyethyl acrylate 2-ethoxyethyl acrylate, and compounds obtained by replacing the acrylate of the aforementioned compound by methacrylate. Examples of an acrylic monomer used for the acrylic polymer having an aromatic ring include styrene, methylstyrene and hydroxystyrene.

In the case where the acrylic polymer is a copolymer, the copolymer may contain an X component (a monomer component having a hydrophilic group) and a Y component (a monomer component having no hydrophilic group), and the molar ratio X/Y is preferably from 1/1 to 1/99. The content of the acrylic polymer is preferably from 1 to 20% by mass based on the cellulose ester. The acrylic polymer may be synthesized with reference, for example, to the method described in JP-A-2003-12859.

### Antioxidant

The optical film of the invention may contain a known antioxidant, such as a phenol antioxidant and a hydroquinone antioxidant, e.g., 2,6-di-tert-butyl-4-methylphenol, 4,4′-thiobis(6-tert-butyl-3-methylphenol), 1,1′-bis(4-hydroxyphenyl)cyclohexane, 2,2′-methylenebis(4-ethyl-6-tert-butylphenol), 2,5-di-tert-butylhydroquinone and pentaerythritol tetrakis[3-(3,5-di-tert-butyl-4-hydroxyphenyl)propionate]. Furthermore, a phosphorous antioxidant may be preferably contained, such as tris(4-methoxy-3,5-diphenyl) phosphite, tris(nonylphenyl) phosphite, tris(2,4-di-tert-butylphenyl) phosphite, bis(2,6-di-tert-butyl-4-methylphenyl)pentaerythritol diphosphite and bis(2,4-di-tert-butylpheny)pentaerythritol diphosphite. The amount of the antioxidant added in the optical film of the invention is preferably from 0.05 to 5.0 parts by mass per 100 parts by mass of the cellulose ester.

### Production Method of Optical Film

The method for producing the optical film of the invention is not particularly limited, and the optical film may be produced by any known method. Examples of the production method include a solution casting film forming method and a melt film forming method. For enhancing the surface property of the optical film, the optical film of the invention is preferably produced by a solution casting film forming method. An embodiment where the optical film is produced by a solution casting film forming method will be described below, but method for producing the optical film of the invention is not limited to a solution casting film forming method. For producing the optical film by a melt casting method, any known method may be used.

### Polymer Solution

In the solution casting film forming method, a polymer solution (i.e., a cellulose ester solution) containing the above cellulose ester, the polyester having a recurring unit represented by the above formula 1, and the various additives depending on necessity is used for forming a web. The polymer solution that may be used in the solution casting film forming method (which may be hereinafter referred to as a cellulose acylate solution) will be described below.

### Solvent

The cellulose ester used in the embodiment is dissolved in a solvent to form a dope, which is then cast on a substrate to form a film. It is necessary in this case to evaporate the solvent after extrusion or casting, a volatile solvent is preferably used.

The solvent is preferably such a solvent that does not undergo reaction with a reactive metal compound, a catalyst and the like, and does not dissolve the substrate for casting. Two or more kinds of solvents may be used in combination.

The cellulose ester and a reactive metal compound may be dissolved in separate solvents respectively, and the resulting solution may be mixed with each other.

An organic solvent that has good solubility is referred to as a good solvent, and a solvent that exhibits major effect of dissolution and is used in a large amount is referred to as a major (organic) solvent.

Examples of the good solvent include a ketone compound, such as acetone, methyl ethyl ketone, cyclopentanone and cyclohexanone, an ether compound, such as tetrahydrofuran (THF), 1,4-dioxane, 1,3-dioxolane and 1,2-dimethoxyethane, and an ester compound, such as methyl formate, ethyl formate, methyl acetate, ethyl acetate, amyl acetate and γ-butyrolactone, and also include methyl cellosolve, dimethylimidazoline, dimethylformamide, dimethylacetamide, acetonitrile, dimethylsulfoxide, sulfolane, nitroethane, methylene chloride and methyl acetoacetate, and 1,3-dioxolane, THF, methyl ethyl ketone, acetone, methyl acetate and methylene chloride are preferred.

The dope preferably contains an alcohol having from 1 to 4 carbon atoms in an amount of from 1 to 40% by mass in addition to the organic solvent.

The alcohol may be used as a gelation solvent, in which after casting the dope on a metal support, the web (a dope film obtained by casting the dope of the cellulose acylate may be referred to as a web) is gelled by increasing the proportion of the alcohol due to evaporation of the solvent, thereby facilitating the release of the web from the metal support, and in the case where the proportion of the alcohol is small, the alcohol may accelerate the dissolution of the cellulose acylate in a non-chlorine organic solvent, and also suppresses a reactive metal compound from being gelled, deposited and increased in viscosity.

Examples of the alcohol having from 1 to 4 carbon atoms include methanol, ethanol, n-propanol, isopropanol, n-butanol, sec-butanol, tert-butanol and propylene glycol monomethyl ether.

Among these, methanol and ethanol are preferred since they have a relatively low boiling point and good drying property, and have no toxicity. The most preferred is ethanol. This kind of organic solvents has no dissolution power to the cellulose ester by itself and thus is referred to as a poor solvent.

The cellulose ester as a raw material of the cellulose ester in the embodiment contains a hydrogen bonding functional group, such as a hydroxyl group, an ester group and a ketone group, and thus the alcohol is preferably contained in the total solvent in an amount of from 5 to 30% by mass, more preferably from 7 to 25% by mass, and further preferably from 10 to 20% by mass, for reducing the releasing load from the casting support.

In the embodiment, water may be contained in a small amount, which is effective for enhancing the viscosity of the solution and the wet web strength on drying, and for enhancing the dope strength on drum casting. For example, water may be contained in an amount of from 0.1 to 5% by mass, preferably from 0.1 to 3% by mass, and particularly preferably from 0.2 to 2% by mass.

Preferred examples of the combination of organic solvents used as the solvent for the polymer solution in the embodiment include those described in JP-A-2009-262551.

A non-halogen organic solvent may be used as the major solvent depending on necessity, the details of which are described in JIII Journal of Technical Disclosure Monthly, 2001-1745, Mar. 15, 2001.

The concentration of the cellulose ester in the polymer solution in the embodiment is preferably from 5 to 40% by mass, more preferably from 10 to 30% by mass, and most preferably from 15 to 30% by mass.

The concentration of the cellulose ester may be controlled to the prescribed concentration in the stage where the cellulose ester is dissolved in the solvent. Alternatively, a solution having a low concentration (for example, from 4 to 14% by mass) may be prepared in advance and then concentrated by evaporating the solvent. A solution having a high concentration may be prepared in advance and the diluted. The concentration of the cellulose ester may be lowered by adding the additive.

The stage where the additive is added may be appropriately determined depending on the kind of the additive. For example, an aromatic ester oligomer and a UV absorbent may be dissolved in an organic solvent, such as an alcohol, e.g., methanol, ethanol and butanol, methylene chloride, methyl acetate, acetone and dioxolane, or a mixed solvent thereof, and then added to the dope, or may be added directly to the dope. A material that is not dissolved in an organic solvent, such as an inorganic powder material, may be dispersed in an organic solvent and the cellulose ester with a dissolver or a sand mill, and then added to the dope.

Examples of the solvent that is most suitable for dissolving the cellulose ester in a high concentration include a mixed solvent of methylene chloride and ethyl alcohol in a ratio of from 95/5 to 80/20, and a mixed solvent of methyl acetate and ethyl alcohol in a ratio of from 60/40 to 95/5.

(1) Dissolving Step

In this step, the cellulose ester and the additive are dissolved in an organic solvent mainly containing a good solvent in a dissolving tank to form a dope, or the cellulose ester solution and the additive solution are mixed to form a dope.

Examples of the method for dissolving the cellulose ester include a method of dissolving under ordinary pressure, a method of dissolving at a temperature lower than the boiling point of the major solvent, a method of dissolving under pressure at a temperature higher than the boiling point of the major solvent, a cooling dissolving method described in JP-A-9-95544, JP-A-9-95557 and JP-A-9-95538, and a method of dissolving under high pressure described in JP-A-11-21379, and a method of dissolving under pressure at a temperature higher than the boiling point of the major solvent is preferably employed.

The concentration of the cellulose ester in the dope is preferably from 10 to 35% by mass. After the additive is added, dissolved and dispersed in the dope after or during the dissolution of the cellulose ester, the dope is preferably filtered with a filter, deaerated and then fed to the next step with a liquid feed pump.

(2) Casting Step

In this step, the dope is fed to a pressure die with a liquid feed pump (such as a pressure metering pump) and cast through the slit of the pressure die onto a casting position of a metal support, such as an endlessly running endless metal belt, e.g., a stainless steel belt, or a rotating metal drum.

The pressure die preferably has at the top thereof a slit capable of being adjusted in the shape thereof for controlling the film thickness uniformly. Examples of the pressure die include a coat hanger die and a T-die, any of which may be preferably used. The metal support has a mirror surface. For enhancing the film forming speed, two or more pressure dies may be provided on the metal support, to which the amount of the dope is distributed, and plural dope films may be laminated. Alternatively, a film having a laminate structure is preferably obtained by a co-casting method, in which plural dopes are cast simultaneously.

(3) Solvent Evaporating Step

In this step, the web (which is a precursor of the completed optical film and contains a large amount of the solvent) is heated on the metal support, thereby evaporating the solvent to such an extent that the web is capable of being released from the metal support.

For evaporating the solvent, such a method may be employed as a method of blowing air from the side of the web, a method of conducting heat with a liquid from the back surface of the metal support, a method of conducting heat by radiation on both the front and back surface thereof, and the like, and a method of conducting heat with a liquid from the back surface is preferred due to the good drying efficiency obtained thereby. Combinations of these methods may also be preferably employed. In the method of conducting heat with a liquid from the back surface, the metal support is preferably heated to a temperature that is lower than the boiling point of the major solvent of the organic solvents used in the dope or the boiling point of the organic solvent having the lowest boiling point therein.

(4) Releasing Step

In this step, the web, from which the solvent has been evaporated on the metal support, is released therefrom at a releasing position. The web thus released is sent to the next step. When the residual solvent amount (see the expression below) of the web on releasing is too large, it may be difficult to release the web, and when the web has been dried excessively on the metal support, the web may be broken partly on releasing.

A gel casting method may be employed as a method of enhancing the film forming speed (the film forming speed may be increased by releasing at a large residual solvent amount as much as possible. Examples of the gel casting method include a method of adding a poor solvent to the cellulose ester to the dope, and gelling the dope after casting the dope, and a method of gelling the dope by decreasing the temperature of the metal support. The dope film may be increased in strength by gelling on the metal support, thereby facilitating the release and increasing the film forming speed.

The residual solvent amount on releasing the web from the metal support is preferably in a range of from 5 to 150% by mass while depending on the strength of the drying condition, the length of the metal support and the like, and in the case where the web is released at a larger residual solvent amount, the residual solvent amount on releasing may be determined in consideration of the economical speed and the quality. In the embodiment, the temperature of the metal support at the releasing position is preferably from −50 to 40° C., more preferably from 10 to 40° C., and most preferably from 15 to 30° C.

The residual solvent amount of the web at the releasing position is preferably from 10 to 150% by mass, and more preferably from 10 to 120% by mass.

The residual solvent amount is expressed by the following expression.

residual solvent amount (% by mass)=[(M−N)/N]×100

wherein M represents the mass of the web at an arbitrary time point, and N represents the mass of the web having the mass M that has been dried at 110° C. for 3 hours.

(5) Drying or Heat-Treating Step and Stretching Step

After the releasing step, the web is preferably dried with a drying device, in which the web is passed through plural rolls alternately, and/or a tenter device, in which the web is conveyed with both terminals thereof held with a clip.

In the case where the web is heat-treated in the embodiment, the heat treatment temperature may be less than (Tg −5° C.), preferably (Tg −20° C.) or more and less than (Tg −5° C.), and more preferably (Tg −15° C.) or more and less than (Tg −5° C.). Tg represents a glass transition temperature.

The heat treatment time is preferably 30 minutes or less, more preferably 20 minutes or less, and particularly preferably approximately 10 minutes.

The measure for drying and heat-treating the web may be generally hot air blown on the web, or may be microwave applied thereto instead of hot air. The temperature, the air flow amount and the time may vary depending on the solvent used, and the conditions may be appropriately selected depending on the kind and the combination of the solvent.

The web may be stretched in any one direction of the film conveying direction (MD: machine direction) and the transversal direction (TD: perpendicular to the film conveying direction) or may be biaxially stretched in both the directions. The web is preferably biaxially stretched. The stretching may be performed by a single step or multiple steps. The tensile modulus may be controlled to the aforementioned range by controlling the kind of the cellulose acylate and the acylation degree thereof, and selecting the additives and controlling the proportions thereof.

The stretching ratio in MD, i.e., the film conveying direction, is preferably from 0 to 20%, more preferably from 0 to 15%, and particularly preferably from 0 to 10%. The stretching ratio (i.e., elongation) of the web on stretching may be achieved by the difference in circumferential speed between the metal support and the releasing speed (e.g., the drawing speed of releasing roll). For example, in the case where an equipment having two nip rolls is used, the rotation speed of the nip roll on the side of outlet is rendered larger than the rotation speed of the nip roll on the side of inlet, thereby stretching the film favorably in the conveying direction, i.e., MD. The tensile modulus in MD may be controlled by performing the stretching.

The stretching ratio (%) referred herein means a value defined by the following expression.

stretching ratio (%)=100×[(length after stretching)−(length before stretching)]/(length before stretching)

The stretching ratio in TD, i.e., the direction perpendicular to the film conveying direction, is preferably from 0 to 30%, more preferably from 1 to 20%, and particularly preferably from 5 to 15%.

In the embodiment, the web is preferably stretched in TD, i.e., the direction perpendicular to the film conveying direction, with a tenter device.

In the biaxial stretching, the web may be relaxed, for example, by from 0.8 to 1.0 time in the film conveying direction to provide a desired retardation value. The stretching ratio may be determined depending on various purposes. The optical film of the invention may be uniaxially stretched in MD in production.

The temperature on stretching is preferably Tg or less, thereby increasing the tensile modulus in the stretching direction. The stretching temperature is preferably from (Tg −50° C.) to Tg, and more preferably from (Tg −30° C.) to (Tg −5° C.). When the web is stretched at a temperature within the range, there is a tendency that the tensile modulus in the stretching direction is increased, whereas the tensile modulus in the direction perpendicular thereto is decreased. Accordingly, for increasing the tensile modulus in both MD and TD, the web is preferably stretched in both the directions, i.e., biaxially stretched, at a temperature within the range.

The web may be dried after stretching. In the case where the web is dried after the stretching step, the drying temperature, the drying air flow amount and the drying time may vary depending on the solvent used, and the drying condition may be appropriately selected depending on the kind of the solvent and the combination thereof. In the embodiment, the drying temperature after the stretching step is preferably lower than the stretching temperature in the stretching step for increasing the front contrast on installing the film in a liquid crystal display device.

(6) Winding Step

The thus resulting film is preferably wound in a length of from 100 to 10,000 m, more preferably from 500 to 7,000 m, and further preferably from 1,000 to 6,000 m, per roll. The width of the film is preferably from 0.5 to 5.0 m, more preferably from 1.0 to 3.0 m, and further preferably from 1.0 to 2.5 m. On winding the film, the film is preferably subjected to knurling on at least one edge thereof, and the knurling preferably has a width of from 3 to 50 mm, and more preferably from 5 to 30 mm, and a height of from 0.5 to 500 μm, and more preferably from 1 to 200 μm. The knurling may be single wheel knurling or double wheel knurling.

The thus obtained web is wound to complete the optical film.

### Layer Structure

The optical film having a functional layer described later may be also referred to as an optical film inclusively with the functional layer, and the optical film except for the functional layer may be referred to as a film containing a cellulose ester. The optical film except for a functional layer used in the invention (i.e., the film containing a cellulose ester) may be a single layer film or may have a laminated layer structure including two or more layers. For example, the optical film preferably has a laminated layer structure containing two layers, a core layer and an outer layer (which may also be referred to as a surface layer or a skin layer), or a laminated layer structure containing three layers, an outer layer, a core layer and an outer layer. The laminated layer structure is preferably produced by co-casting.

In the case where the optical film of the invention has a laminated layer structure containing two or more layers, the outer layer preferably contains a matting agent. Examples of the matting agent used include those described in JP-A-2011-127045, and for example, silica particles having an average particle size of 20 nm may be used.

### Thickness of Optical Film

The thickness of the optical film is from 10 to 45 preferably from 15 to 35 μm, more preferably from 15 to 30 and particularly preferably less than 30 μm from the standpoint of thin film thickness

The in-plane retardation (Re) at a wavelength of 590 nm under an environment of 25° C. and 60% RH of the optical film is preferably from −5 to 5 nm, more preferably from 0 to 5 nm, and particularly preferably from 0 to 3 nm.

### Retardation of Optical Film

The in-plane retardation (Re) at a wavelength of 590 nm under an environment of 25° C. and 60% RH of the optical film of the invention is preferably from −5 to 5 nm, more preferably from 0 to 3 nm, and further preferably from 0 to 2 nm.

The retardation in thickness direction (Rth) at a wavelength of 590 nm under an environment of 25° C. and 60% RH of the optical film of the invention is preferably from −5 to 5 nm, more preferably from −3 to 3 nm, and further preferably −2 to 2 nm.

The values Re(λ) and Rth(λ) herein mean the in-plane retardation and the retardation in thickness direction, respectively, at a wavelength λ. The wavelength λ herein is 590 nm unless otherwise indicated in the specification. Re(λ) may be measured with KOBRA 21ADH (available from Oji Scientific Instruments Co., Ltd.) by making light having a wavelength of λ nm incident in the normal line direction of the film. Rth(λ) may be obtained in such a manner that Re(λ) is measured for 6 points by making light having a wavelength of λ nm incident at angles of from the normal line direction to 50° for each terminals with a step of 10° with the in-plane retardation axis being the tilting axis (rotation axis) (when there is no retardation axis, an arbitrary direction within the plane of the film is designated as the rotation axis), and Rth(λ) is calculated with KOBRA 21ADH based on the retardation values thus measured, the assumed value of the average refractive index and the thickness of the film thus input. Rth may also be obtained in such a manner that retardation values are measured in arbitrary two directions with the retardation axis being the tilting axis (rotation axis) (when there is no retardation axis, an arbitrary direction within the plane of the film is designated as the rotation axis), and Rth is calculated from the following expressions (A) and (B) based on the retardation values thus measured, the assumed value of the average refractive index and the thickness of the film thus input. The assumed value of the average refractive index used herein may be values shown in Polymer Handbook (John Wiley & Sons, Inc.) and catalogs of various optical films. For a film with no known average refractive index, the refractive index thereof may be measured with an Abbe refractometer. The average refractive indices of major optical films are shown below: cellulose acylate (1.48), cycloolefin polymer (1.52), polycarbonate (1.59), polymethylmethacrylate (1.49) and polystyrene (1.59). KOBRA 21ADH calculates nx, ny and nz based on the assumed value of the average refractive index and the thickness of the film thus input, and based on nx, ny and nz, Nz=(nx−nz)/(nx−ny) is further calculated.

$$\begin{matrix}Re ( θ ) = [ nx - \frac{ny \times nz}{\sqrt{ \begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} & Expression ( A ) \\ Rth = ( ( nx + ny ) / 2 - nz ) \times d & Expression ( B )\end{matrix}$$

Re(θ) represents the retardation value in the direction that is tilted from the normal line direction by an angle θ, nx, ny and nz represent the refractive indices of the index ellipsoid in the main axis azimuths respectively, and d represents the thickness of the film.

Tensile Modulus of Optical Film The tensile modulus (tensile elastic modulus) of the optical film of the invention is preferably 4.2 GPa or more, more preferably 4.3 GPa or more, and particularly preferably 4.5 GPa or more. The upper limit of the tensile modulus is not particularly limited and is generally 10 GPa or less. When the tensile modulus is 4.2 GPa or more, the film may have an enhanced rigidity. When the optical film of the invention has high rigidity, the optical film that has a reduced thickness may have good handling property, thereby providing a film that has excellent film surface smoothness and high deformation resistance on storing after winding the film and has a less amount of appearance failure (which may be referred to as a concave dent bump, pits (beko)). The optical film having a high tensile modulus is less likely to generate film-surface defects such as pits and wrinkles locally.

The tensile modulus may be measured in such a manner that the stress at an elongation of 0.5% is measured with a versatile tensile tester “STM T50BP”, available from Baldwin Japan, Ltd., at a tensile speed of 10% per minute at 23° C. and 60% RH, and the average value of the tensile moduli in MD and TD is designated as the tensile modulus.

### Use of Optical Film

The optical film of the invention is useful as various purposes including a protective film for a polarizing plate, a surface protective film disposed on an image display surface, and the like. For imparting functions suitable for the purposes, the optical film of the invention may have, for example, a hardcoat layer, an antiglare layer, a clear hardcoat layer, an antireflection layer, an antistatic layer and an antifouling layer.

The optical film of the invention contains the film containing the cellulose ester described above, and thus has good adhesion property to a polarizer, and therefore the optical film is suitable for the use in a liquid crystal display device having a polarizing plate as an essential member.

The protective film for a polarizing plate used on the front side of the display device such as a liquid crystal display device preferably has an antiglare layer and a clear hardcoat layer, and also an antireflection layer, an antistatic layer and an antifouling layer.

In the production of a polarizing plate with the optical film of the invention that has an in-plane retardation axis, the optical film is preferably adhered in such a manner that the in-plane retardation axis is in parallel to or perpendicular to the transmission axis of the polarizer.

### Polarizing Plate

The polarizing plate of the invention contains a polarizer and at least one sheet of the optical film of the invention.

The polarizing plate of the invention may be produced by an ordinary method. For example, the polarizing plate may be produced by adhering a polarizer on one surface of the optical film of the invention. The adhesion surface of the optical film is preferably subjected to an alkali saponification treatment. A fully saponified polyvinyl alcohol aqueous solution may be used for the adhesion.

The polarizer used in the polarizing plate may be any ordinary one. Examples thereof include a polarizer obtained by treating a film formed of a hydrophilic polymer, such as polyvinyl alcohol or ethylene-modified polyvinyl alcohol having an ethylene unit content of from 1 to 4% by mol, a polymerization degree of from 2,000 to 4,000 and a saponification degree of from 99.0 to 99.99° by mol, with a dichroic dye, such as iodine, followed by stretching, and a polarizer obtained by treating and orienting a plastic film, such as polyvinyl chloride.

The thickness of the polarizer used is preferably from 5 to 30 μm. The polarizer thus obtained is adhered to the optical film of the invention. When the thickness of the polarizer is reduced, the durability of the polarizer is liable to be deteriorated, but the optical film of the invention may improve the durability of the polarizer under a high temperature and high humidity condition, and thus the optical film is preferably applied to the case where the polarizer has a reduced thickness. In particular, the optical film of the invention is preferably adhered to a polarizer having a thickness of from 5 to 20 μm, and more preferably adhered to a polarizer having a thickness of from 5 to 15 μm.

On the surface of the polarizer opposite to the surface having the optical film of the invention adhered, another optical film according to the invention may be adhered, or a known optical film may be adhered.

While the known optical film used is not limited in the optical characteristics and the material thereof, optical films formed of an acrylic resin and/or a cyclic olefin resin may be preferably used, and both an optically isotropic film and an optically anisotropic retardation film may be used.

Examples of the known optical film that contains a cellulose ester resin include Fujitac TD40UC (available from Fujifilm Corporation).

Examples of the known optical film that contains an acrylic resin include the optical film containing a (meth)acrylic resin containing a styrene resin described in Japanese Patent No. 4,570,042, the optical film containing a (meth)acrylic resin having a glutarimide ring structure in the main chain thereof described in Japanese Patent No. 5,041,532, the optical film containing a (meth)acrylic resin having a lactone ring structure described in JP-A-2009-122664, and the optical film containing a (meth)acrylic resin having a glutaric anhydride unit described in JP-A-2009-139754.

Examples of the known optical film that contains a cyclic olefin resin include the cyclic olefin resin film described in JP-A-2009-237376, paragraphs 0029 et seq., and the cyclic olefin resin film containing an additive that reduces Rth described in Japanese Patent No. 4,881,827 and JP-A-2008-063536.

In an embodiment where the polarizing plate according to the invention is used in a liquid crystal display device, both cases may be preferred where the optical film of the invention is disposed on the inner side of the polarizer (i.e., between the polarizer and the liquid crystal cell) and on the outer side of the polarizer (i.e., on the side of the polarizer opposite to the liquid crystal cell), and the optical film of the invention is preferably disposed between the polarizer and the liquid crystal cell.

### Liquid Crystal Display Device

The liquid crystal display device of the invention has a liquid crystal cell and two polarizing plates disposed on both sides of the liquid crystal cell. At least one of the polarizing plates is the polarizing plate of the invention. The function of the optical film of the invention in the liquid crystal display device is not particularly limited. One example of the position where the optical film of the invention is disposed is a surface protective film of a polarizing plate disposed on the side of the backlight of the liquid crystal display device having no hardcoat layer, in which the surface protective film is disposed between the polarizer and the liquid crystal cell (i.e., on the surface of the polarizer on the side of the liquid crystal cell). Another example of the position where the optical film of the invention is disposed is a surface protective film of a polarizing plate disposed on the side of the display surface of the liquid crystal display device having no hardcoat layer, in which the surface protective film is disposed between the polarizer and the liquid crystal cell (i.e., on the surface of the polarizer on the side of the liquid crystal cell). Thus, in the liquid crystal display device of the invention, the optical film of the invention is preferably disposed between a polarizer and a liquid ¥crystal cell.

The other structures and materials of the liquid crystal display device may be ones that are known for known liquid crystal display devices. The display mode of the liquid crystal cell is not particularly limited, and liquid crystal display devices having various display modes are included, such as TN (twisted nematic) mode liquid crystal cell, IPS (in-plane switching) mode liquid crystal cell, FLC (ferroelectric liquid crystal) mode liquid crystal cell, AFLC (anti-ferroelectric liquid crystal) mode liquid crystal cell, OCB (optically compensatory bend) mode liquid crystal cell, STN (super twisted nematic) mode liquid crystal cell, VA (vertically aligned) mode liquid crystal cell and HAN (hybrid aligned nematic) mode liquid crystal cell. The liquid crystal cell used in the liquid crystal display device of the invention is preferably an in-plane switching IPS mode liquid crystal cell,

### EXAMPLES

The features of the invention will be described in more detail with reference to examples below. The materials, the amounts and ratios thereof used, the contents of processes, the procedures of processes, and the like in the examples may be modified as far as they do not deviate from the substance of the invention. Accordingly, the invention is not construed as being limited to the following examples.

### Example 1

### Production of Cellulose Acylate Dope for Core Layer

The following components were placed in a mixing tank and dissolved with agitation to prepare a cellulose acetate solution which was to be used as a cellulose acylate dope for a core layer:

### <Cellulose Acylate Dope for Core Layer>

| | | |
|---|---|---|
| Cellulose acetate having acetylation | 100 | parts by mass |
| degree of 2.88 | | |
| Polyester A | 12 | parts by mass |
| Methylene chloride (first solvent) | 430 | parts by mass |
| Methanol (second solvent) | 64 | parts by mass |

The following Table 1 shows the structure of polyester A and the structures of polyesters used in the below-described Examples and Comparative Examples.

TABLE 1

| | Molar Content [%] | | | | | | | |
|---|---|---|---|---|---|---|---|---|
| | Dicarboxylic Acid | | | Diol | | | Terminal | |
| Polyester | 4-Me-1,2-CHA | 1,2-CHA | AA | EG | PG | Mn | Structure | Note |
| A | 50 | 0 | 0 | 50 | 0 | 850 | CHA | Invention |
| B | 50 | 0 | 0 | 50 | 0 | 1200 | CHA | Invention |
| C | 50 | 0 | 0 | 40 | 10 | 990 | CHA | Invention |
| D | 50 | 0 | 0 | 50 | 0 | 1000 | 4MCHA | Invention |
| E | 0 | 50 | 0 | 50 | 0 | 800 | CHA | Invention |
| F | 50 | 0 | 0 | 50 | 0 | 1000 | OH | Comparative |
| G | 50 | 0 | 0 | 50 | 0 | 950 | C6A | Comparative |
| H | 0 | 0 | 50 | 50 | 0 | 900 | CHA | Comparative |
| I | 0 | 50 | 0 | 25 | 25 | 980 | OH | Comparative |

The abbreviations in Table 1 have the following meanings: 4-Me-1,2-CHA: 4-methyl-1,2-cyclohexanedicarboxylic acid 1,2-CHA: 1,2-cyclohexanedicarboxylic acid

AA: adipic acid
EG: ethylene glycol
PG: propylene glycol
Mn: number average molecular weight

The abbreviations in the terminal structure of Table 1 have the following meanings:

CHA: the hydrogen atoms of the hydroxyl groups in both terminals of the polyester are substituted (blocked) with cyclohexyanoyl group
4MCHA: the hydrogen atoms of the hydroxyl groups in both terminals of the polyester are substituted (blocked) with 4-methylcyclohexanoyl group
C6A: the hydrogen atoms of the hydroxyl groups in both terminals of the polyester are substituted (blocked) with n-hexanoyl group.
OH: the both terminals of the polyester are a hydroxyl group

### Production of Cellulose Acylate Dope for Outer Layer

10 parts by mass of a matting agent solution shown below was added to 90 parts by mass of the cellulose acylate dope for core layer produced above to prepare a cellulose acetate solution which was to be used as a cellulose acetate solution for an outer layer.

### <Matting Agent Solution>

| | | |
|---|---|---|
| Silica particles having average particle | 2 | parts by mass |
| diameter of 20 nm (Aerosil R972, available | | |
| from Nippon Aerosil Co., Ltd.) | | |
| Methylene chloride (first solvent) | 76 | parts by mass |
| Methanol (second solvent) | 11 | parts by mass |
| Cellulose acylate dope for core layer | 1 | part by mass |

### Production of Optical Film

The cellulose acylate dope for core layer and the cellulose acylate dope for outer layer were filtered with filter paper having an average pore diameter of 34 μm and a sintered metal filter having an average pore diameter of 10 μm, and cast simultaneously for three layers from the casting outlets onto a drum at 20° C. (band casting machine) in such a manner that the outer layer cellulose acylate dope was cast on both sides of the core layer cellulose acylate dope. The film was released in the state where the solvent content thereof was 20% by mass, and the film was dried while stretching by the stretching ratio of 1.1 times in the direction perpendicular to the film conveying direction with both edges of the film being fixed with tenter clips. Thereafter, the film was further dried by conveying among rolls of a heat treatment device, thereby producing an optical film having a thickness of 18 μm, which was designated as an optical film of Example 1. The optical film of Example 1 has a core layer of 11 μm thick and outer layers of 2 μm thick disposed on both sides of the core layer.

### Examples 2 to 9 and Comparative Examples 1 to 5

Optical films of Examples 2 to 9 and Comparative Examples 1 to 5 were produced in the same manner as in the production of the optical film of Example 1 except that the kind and the amount of the polyester used in the optical film and the thickness and stretching ratio of the film were changed as shown in Table 2.

In Comparative Example 5, the polyester described in Example 1 of WO 2014/027594 was used.

### Evaluation

### Evaluation of Optical Films

The optical films of Examples and Comparative Examples were subjected to the following evaluation. The results of the evaluation are shown in Table 2.

### Optical Performance

The optical films of Examples and Comparative Examples each were measured for retardation at a wavelength of 590 nm with KOBRA 21ADH (available from Oji Scientific Instruments Co., Ltd.) after storage under an environment of 25° C. and 60% RH for 1 hour.

### Measurement of Tensile Modulus

Stress at 0.5% elongation was measured at a tensile rate of 10%/minute under an atmosphere of 23° C. and 60% RH using a universal tensile tester STM T50BP manufactured by Toyo Baldwin to determine tensile modulus which is an average of the measured tensile modulus in MD and the measured tensile modulus in TD.

### Evaluation of Pits

The optical films of Examples and Comparative Examples of 3900 m length were rolled up to a roll and stored under an atmosphere of 23° C. and 60% RH for 2 weeks. Appearance was observed by eyes an evaluated based on the following standards: Results are shown on Table 2.

A: No deformation of the roll
B: the roll surface was deformed to be uneven.

When pits are generated on the surface of the roll, the optical film also has an uneven surface such as pits pattern. Polarizing plate produced by using the optical film causes display unevenness. The grade A is practically required.

### Evaluation of Polarizing Plate

### Production of Polarizing Plate

### (1) Saponification of Film

The optical films of Examples and Comparative Examples and Fujitac TD40UC (available from Fujifilm Corporation) each were immersed in a 4.5 mol/L sodium hydroxide aqueous solution (saponification solution) controlled to 37° C. for 1 minute, washed with water, subsequently immersed in a 0.05 mol/L sulfuric acid aqueous solution for 30 seconds and then rinsed in a water bath. The optical films each were dehydrated by subjecting to draining with an air knife three times, and then dried by retaining in a drying zone at 70° C. for 15 seconds, thereby producing saponified films.

In the case where an optical film received B rank in the evaluation of pits, a polarizing plate was produced by using a part of the film where no pits were observed.

### (2) Production of Polarizer

The film was stretched in the film conveying direction by passing through two pairs of nip rolls, to which a difference in circumferential speed was applied, according to Example 1 of JP-A-2001-141926, thereby preparing a polarizer having a thickness of 12 μm.

### (3) Adhesion

Two sheets were selected from the aforementioned saponified optical films and were disposed on both sides of the polarizer, and the films were adhered to each other by a roll-to-roll process with a 3% PVA aqueous solution of polyvinyl alcohol (PVA-117H, available from Kuraray Co., Ltd.) as an adhesive in such a manner that the polarizing axis of the polarizer was perpendicular to the film conveying direction of the optical films, thereby producing a polarizing plate. In the polarizing plate, the film on one side of the polarizer was one selected from the saponified films obtained by saponifying the optical films of Examples and Comparative Examples, and the film on the other side of the polarizer was the film obtained by saponifying Fujitac TD40UC (available from Fujifilm Corporation).

### Evaluation of Polarizer Durability

The polarizing plates thus produced above each were adhered on the side of the optical films of Examples and Comparative Examples to a glass plate with a pressure-sensitive adhesive, thereby preparing two pairs of specimens each having a size of approximately 5 cm×5 cm. The specimens were disposed to form crossed nicols, which were measured for crossed nicols transmittance at a wavelength of 410 nm and 730 nm with an automatic polarizing film measuring machine, VAP-7070, available from Jasco Corporation. Thereafter, the specimens having been stored under a high temperature high humidity environment of 60° C. and 90% RH for 500 hours were measured for crossed nicols transmittance in the same manner as above. The polarizer durability of the polarizing plate is defined by the change rate of the crossed nicols transmittance as follows.

evaluation value of polarizer durability of polarizing plate=[(crossed nicols transmittance after storing (%))−(crossed nicols transmittance before storing (%))]/(crossed nicols transmittance before storing (%))

The polarizing plate is free of any practical problem when the evaluation value of the polarizer durability of the polarizing plate at 410 nm is 10 or less, and the evaluation value of the polarizer durability is preferably 8 or less, and more preferably 7 or less.

The polarizing plate is free of any practical problem when the evaluation value of the polarizer durability of the polarizing plate at 730 nm is 6 or less, and the evaluation value of the polarizer durability is preferably 4 or less, and more preferably 3 or less.

The results obtained are shown in Table 2.

### Evaluation of Liquid Crystal Display Device

Evaluation on mounting in IPS Liquid Crystal Display Device

In commercially available liquid crystal television sets (an IPS mode low-profile 42-inch liquid crystal television set), the polarizing plates holding the liquid crystal cell were peeled off from the liquid crystal cell, and the polarizing plates of Examples and Comparative Examples produced by the above process each were adhered again with a pressure-sensitive adhesive to the liquid crystal cell with the side of the optical films of Examples and Comparative Examples shown in Table 2 below directed to the side of the liquid crystal cell. The thus refabricated television sets each were evaluated for the display characteristics by observing the luminance and the color tone from the front and the diagonal direction with the following standard.

A: The display characteristics were equivalent to the original commercially available television set for the luminance and the color tone from the front and the diagonal direction.
B: The display characteristics were inferior to the original commercially available television set for the luminance and the color tone from the diagonal direction.

The grade A is practically required.

The results obtained are shown in Table 2 below.

Evaluation of Application to Polarizing Plate after Durability Test and Durability Evaluation of Application to IPS Liquid Crystal Display Device

In commercially available liquid crystal television sets (an IPS mode low-profile 42-inch liquid crystal television set), the polarizing plates holding the liquid crystal cell were peeled off from the liquid crystal cell, and the polarizing plates produced above each were adhered again with a pressure-sensitive adhesive to the liquid crystal cell with the side of the optical films of Examples and Comparative Examples directed to the side of the liquid crystal cell. The thus refabricated television sets each were retained under an environment of 60□ C. and 90% RH for 500 hours, and then transferred to an environment of 25□ C. and 60% RH, in which the television sets were being turned on with a black solid image displayed, and visually evaluated after 48 hours.

The television sets were observed from the front thereof and evaluated with the following standard.

AA: The contrast was substantially not changed from before the durability test, and the image was clearly confirmed.
A: The contrast was slightly reduced from before the durability test, and the image was confirmed without any problem.
B: The contrast was somewhat reduced from before the durability test (the reduction in contrast was larger than the grade A but was not clearer than in the grade C), and the image was slightly unclear.
C: The contrast was clearly reduced from before the durability test, and the image was unclear.

The grades AA, A and B are practically required, the grades AA and A are preferred, and the grade AA is more preferred.

The results obtained are shown in Table 2.

TABLE 2

| | | | | | | | | | | | | | | | | Evaluation | | Evaluation | Evaluation |
|---|---|---|---|---|---|---|---|---|---|---|---|---|---|---|---|---|---|---|---|
| | | | | | | | | | | | | | | | | Value of | | of Applica- | of Applica- |
| | | | | | | | | | | | | | | | | Polarizer | | tion to | tion to |
| | | | | | | | | | | Thick- | Stretch- | Retarda- | | | | Durability in | | Polarizing | Polarizing |
| | Polyester | | | | | | | | | ness of | ing | tion | | Tensile | | Polarizing Plate | | Plate before | Plate after |
| | [mass % based on cellulose ester] | | | | | | | | | Film | Ratio | [nm] | | Modulus | | 410 | 730 | Durability | Durability |
| | A | B | C | D | E | F | G | H | I | [μm] | in TD | Re | Rth | [GPa] | Pits | nm | nm | Test | Test |
| Example 1 | 12 | | | | | | | | | 15 | 1.1 | 0 | 2 | 4.6 | A | 5 | 3 | A | A |
| Example 2 | 13 | | | | | | | | | 20 | 1.1 | 0 | 1 | 4.7 | A | 5 | 2 | A | A |
| Example 3 | 10 | | | | | | | | | 18 | 1.1 | 0 | 3 | 4.5 | A | 4 | 2 | A | A |
| Example 4 | | 15 | | | | | | | | 20 | 1.1 | 0 | 0 | 4.8 | A | 6 | 3 | A | A |
| Example 5 | | | 10 | | | | | | | 20 | 1.1 | 0 | −1 | 4.4 | A | 6 | 4 | A | A |
| Example 6 | | | | 15 | | | | | | 20 | 1.1 | 0 | 0 | 4.8 | A | 6 | 3 | A | A |
| Example 7 | | | | | 13 | | | | | 20 | 1.1 | 0 | 1 | 4.7 | A | 8 | 5 | A | B |
| Example 8 | | 12 | | | | | | | | 25 | 1.1 | 0 | 3 | 4.6 | A | 6 | 4 | A | A |
| Example 9 | | | | 12 | | | | | | 25 | 1.2 | 0 | 5 | 4.8 | A | 7 | 4 | A | A |
| Compar- | | | | | | 13 | | | | 20 | 1.1 | 0 | 1 | 4.7 | A | 11 | 9 | A | C |
| ative | | | | | | | | | | | | | | | | | | | |
| Example 1 | | | | | | | | | | | | | | | | | | | |
| Compar- | | | | | | | 15 | | | 20 | 1.1 | 0 | 0 | 4.0 | B | 12 | 9 | A | C |
| ative | | | | | | | | | | | | | | | | | | | |
| Example 2 | | | | | | | | | | | | | | | | | | | |
| Compar- | | | | | | | 7 | | | 20 | 1.1 | 0 | 7 | 4.3 | A | 7 | 4 | B | A |
| ative | | | | | | | | | | | | | | | | | | | |
| Example 3 | | | | | | | | | | | | | | | | | | | |
| Compar- | | | | | | | | 13 | | 20 | 1.1 | 0 | −1 | 3.7 | B | 17 | 26 | A | C |
| ative | | | | | | | | | | | | | | | | | | | |
| Example 4 | | | | | | | | | | | | | | | | | | | |
| Compar- | | | | | | | | | 15 | 20 | 1.1 | 0 | 0 | 4.8 | A | 13 | 11 | A | C |
| ative | | | | | | | | | | | | | | | | | | | |
| Example 5 | | | | | | | | | | | | | | | | | | | |

It was understood from Table 2 that the optical films of Examples 1 to 9 achieved a thin film thickness, and were capable of achieving optical characteristics with a low retardation, excellent surface smoothness and high durability of a polarizer under a high temperature and high humidity environment on application as a polarizing plate protective film to a polarizing plate.

The results in Table 2 will be described more specifically below.

The optical films of Examples 1 to 9 and Comparative Examples 1, 3 or 5 had a high tensile modulus, generated no pits after storage in the form of roll for two weeks, and had an excellent film surface smoothness. The optical films of Comparative Examples 2 and 4 had a small tensile modulus, generated pits after storage in the form of roll for two weeks, and thus were not suitable for practical use.

The optical film of Comparative Example 3 had Rth exceeding the upper limit determined in the invention. In the application test of a polarizing plate before the durability test, the liquid crystal television set refabricated by changing to the polarizing plate of Comparative Example 3 produced by using the optical film of Comparative Example 3 having Rth exceeding the upper limit determined in the invention suffered large color tone change viewed from the diagonal direction, and thus was confirmed to have deteriorated display characteristics. The liquid crystal television sets refabricated by changing to the polarizing plates of Examples 1 to 9 and Comparative Examples 1, 2, 4 and 5 each exhibited display characteristics equivalent to the original commercially available television set before peeling off and changing the polarizing plates.

The optical films of Examples 1 to 9 and Comparative Example 3 each had a small change in orthogonal transmission and had good durability of the polarizer under a high temperature and high humidity environment. The polarizing plate produced with the optical films of Comparative Examples 1, 2, 4 and 5 had a large change in orthogonal transmission with the lapse of time, and suffered significant decoloration of the polarizer, and thus it was found that the optical films had a problem in durability of the polarizer under a high temperature and high humidity environment. In the application test of a polarizing plate after the durability test, the liquid crystal display devices using the polarizing plates of Examples 1, 6, 8 and 9 and Comparative Example 3 were able to display the image clearly even after the durability test. The liquid crystal display devices using the polarizing plates of Example 7 was free of any practical problem although displayed image was slightly unclear due to somewhat reduced contrast. The liquid crystal display devices using the polarizing plates of Comparative Examples 1, 2, 4 and 5 were reduced in contrast as compared to before the durability test, and it was confirmed that the images displayed thereby were unclear.

While the invention has been described in detail and with reference to specific embodiments thereof, it will be apparent to one skilled in the art that various changes and modifications can be made therein without departing from the spirit and scope thereof.

The present disclosure relates to the subject matter contained in Japanese Patent Application No. 113536/2014, filed on May 30, 2014, the contents of which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims.

What is claimed is:

1. An optical film containing:
a cellulose ester, and
a polyester having a recurring unit represented by the formula 1 below and having a terminal blocked with a group having an alicyclic structure,
wherein:
the optical film has a thickness of from 10 to 45 μm,
the optical film has an in-plane retardation, Re, of from −5 to 5 nm at a wavelength of 590 nm under an environment of 25° C. and a relative humidity of 60%, and
the optical film has a retardation in thickness direction, Rth, of from −5 to 5 nm at a wavelength of 590 nm under an atmosphere at 25° C. and a relative humidity of 60%: 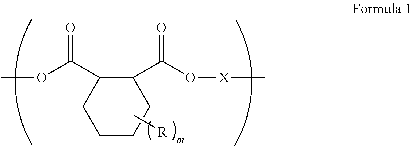
wherein X represents a divalent linking group having from 2 to 10 carbon atoms,
R represents an alkyl group having from 1 to 8 carbon atoms, an alkenyl group having from 2 to 8 carbon atoms, an alkynyl group having from 2 to 8 carbon atoms, or an aryl group having 6 carbon atoms, R may form a cyclic structure and may have a substituent; the above numbers of carbon atoms do not include the number of carbon atoms in a substituent the group represented by R may further have; and
m represents an integer of from 0 to 4.

2. The optical film according to claim 1 wherein the polyester has a number average molecular weight, Mn, of from 500 to 3000.

3. The optical film according to claim 1 wherein X in the formula 1 an acyclic divalent linking group having from 2 to 4 carbon atoms.

4. The optical film according to claim 1 wherein the group having an alicyclic structure is a group having a cycloalkyl group having 4 to 12 carbon atoms.

5. The optical film according to claim 1 wherein the group having an alicyclic structure is a group having a cycloalkyl group having 6 to 12 carbon atoms and the group having a cycloalkyl group having 6 to 12 carbon atoms has at least one cyclohexyl ring.

6. The optical film according to claim 1 wherein the polyester is contained in an amount of from 5 to 20% by mass based on the amount of the cellulose ester.

7. A polarizing plate containing a polarizer and at least one sheet of the optical film of claim 1.

8. A liquid crystal display device containing a liquid crystal cell and two polarizing plates disposed on both sides of the liquid crystal cell, wherein at least one of the polarizing plates is the polarizing plate of claim 7.

9. The liquid crystal display device according to claim 8, wherein the liquid crystal cell is an in-plane switching IPS mode liquid crystal cell.

10. The liquid crystal display device according to claim 8, wherein the optical film of claim 1 is disposed between the polarizer and the liquid crystal cell.
